(19) United States
(12) Patent Application Publication
(10) Pub. No.: US 2002/0084988 A1
(43) Pub. Date: Jul. 4, 2002

(54) Apparatus and method for automatically detecting USB mode and PS/2 mode computer keyboard

(76) Inventor: Shih-Jen Kuo, Taipei (TW)

Correspondence Address: BACON & THOMAS, PLLC, 4th Floor, 625 Slaters Lane, Alexandria, VA, 22314-1176, US

(21) Appl. No.: 09/824,004

(22) Filed: Apr. 3, 2001

(30) Foreign Application Priority Data
Jan. 2, 2001 (TW) 90100072

(51) Int. Cl. G09G 5/00

(52) U.S. Cl. 345/168

(57) ABSTRACT

An apparatus and method capable to automatically detect and determine a computer keyboard in operation with USB mode or PS/2 mode is described. In an external connector mode, the apparatus comprises a central processing unit (CPU) with a power port, a ground port, and a first and second USB and PS/2 shared ports to connect with a USB connector or a PS/2 connector and detect the first and second USB and PS/2 shared ports to determine the computer keyboard in operation with USB mode or PS/2 mode. In a Y-cable mode, the apparatus comprises a CPU connected with a USB connector and a PS/2 connectors, and a mode detection circuit respectively connected to the power terminals of the USB connector and the PS/2 connector and outputting a first or second mode signal to the mode detection port on the CPU so as to determine the computer keyboard in operation with USB mode or PS/2 mode.

### FIELD OF THE INVENTION

The present invention relates generally to a computer keyboard, and more particularly, to an apparatus and method capable to automatically detect and determine a computer keyboard in operation with USB mode or PS/2 mode.

### BACKGROUND OF THE INVENTION

Computer peripheral has to be equipped with a connector of the same port standard as that on printed circuit board (PCB) of the computer system to be connected for communication interface match between the peripheral and the computer system. While there are various port standards for connectors, which in turn results in that each peripheral has to be manufactured with each type connector, typically USB connector and PS/2 connector, adaptively to different computer hosts, and they cannot be replaced or shared with each other.

Currently the USB port is becoming prevailing and predominant. It is most commonly used on the notebook computer, and at the same time, it is also more and more used on the desktop computer. In either case, replacing other traditional connectors with the USB connector seems becoming a definite trend. However, the commonly used PS/2 connector is still required on the computer keyboard so as to facilitate the computer users to adapt themselves to the computer system equipped with the PS/2 port. Therefore, a computer keyboard with both USB mode and PS/2 mode is desired and consequently the goal of resources saving and cutting down on the production cost can be achieved.

Further, the USB port has the characteristics and advantages of cascading external apparatus. In addition, the mouse generally has to be directly connected with the computer host, which is inconvenient for the computer user to plug and unplug it, and therefore the keyboard with the capability to externally connect with a mouse is proposed. However, such computer keyboard is only available for USB connection, but not for PS/2 connection.

In order to provide the user with a computer keyboard with both USB mode and PS/2 mode and with the convenience of plugging and unplugging it so as to avoid incorrect connection or setup, an apparatus for computer keyboard applicable to both USB port and PS/2 port and method able to automatically detect USB mode and PS/2 mode is desired.

### SUMMARY OF THE INVENTION

The primary object of the present invention is to provide an apparatus and method for automatically detecting USB mode and PS/2 mode computer keyboard, which can automatically detect the connector on the computer system that is connected with the keyboard so as to determine the keyboard in operation with USB mode or PS/2 mode.

According to the present invention, an apparatus and method for automatically detecting USB mode and PS/2 mode computer keyboard in an external connector mode comprises a central processing unit (CPU) with a power port, a ground port, and a first and second USB and PS/2 shared ports to connect with a USB connector or PS/2 connector. The power port, ground port, and first and second USB and PS/2 shared ports of the CPU are respectively connected to the power terminal, ground terminal, data plus (DP) terminal and data minus (DM) terminal of a USB connector or the power terminal, ground terminal, data terminal and clock terminal of a PS/2 connector. When the keyboard is connected to a computer host, the CPU detects the first and second USB and PS/2 shared ports to determine that a USB connector or a PS/2 connector is used and in turn the computer keyboard in operation with USB mode or PS/2 mode depending on the detection. An apparatus and method for automatically detecting USB mode and PS/2 mode computer keyboard in a Y-cable mode comprises a CPU, a mode detection circuit, a USB connector and a PS/2 connector. The mode detection circuit has two input terminals that are respectively connected to the power terminals of the USB connector and PS/2 connector and an output terminal that is connected and provides a first or second mode signal to a mode detection port of the CPU so as to determine the computer keyboard in operation with USB mode or PS/2 mode. When the keyboard is connected to a computer host, the mode detection port of the CPU determines the connector used is a USB connector or a PS/2 connector depending on the first and second mode signal. The mode detection circuit includes a mode switch to generate the first or second mode signal in consideration of signals on the two input terminals of the mode detection circuit. The first mode signal is a high state signal and determines the keyboard in operation with USB mode; while the second mode signal is a low state signal and determines the keyboard in operation with PS/2 mode. If the USB connector is used and the PS/2 connector is free, then the power terminal, data plus terminal, data minus terminal and ground terminal of the USB connector are respectively connected to the power port, data plus port, data minus port and ground port of the CPU, and the signal on the power respectively of the USB connector makes the mode detection circuit output the first mode signal. If the PS/2 connector is used, then its data terminal, clock terminal and ground terminal are respectively connected to the data port, clock port and ground port of the CPU and its power terminal controls the mode switch of the mode detection circuit, by which the power terminal will turn on the mode switch and thus make the mode detection circuit output the second mode signal as long as the PS/2 connector is connected.

Another PS/2 connector is also provided to connect with an external mouse or other peripheral. Moreover, the CPU further includes a control port to output a control signal to an electronic switch, by which the another PS/2 connector is enabled or disabled by tuning on or turning off the electronic switch. When the keyboard operates with USB mode, the another PS/2 connector is enabled; while the another PS/2 connector is disabled when the keyboard operates with PS/2 mode.

### BRIEF DESCRIPTION OF THE DRAWINGS

For a better understanding of the present invention, reference may be had to the following description of exemplary embodiments thereof, considered in conjunction with the accompanying drawings, in which:

FIG. 1 is an illustrative diagram of one embodiment computer keyboard according to the present invention;

FIG. 2 is an exemplary circuit diagram for the embodiment shown in FIG. 1;

FIG. 3 demonstrates a detection workflow for the circuit shown in FIG. 2;

FIG. 4 is an illustrative diagram of a second embodiment computer keyboard according to the present invention;

FIG. 5 is an exemplary circuit diagram for the embodiment shown in FIG. 4; and

FIG. 6 demonstrates a detection workflow for the circuit shown in FIG. 5.

### DETAILED DESCRIPTION OF THE INVENTION

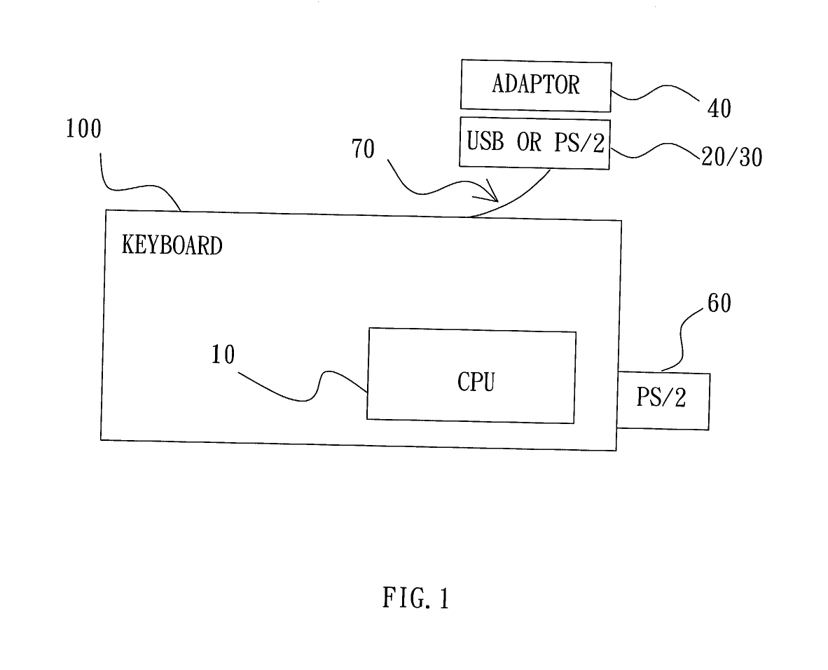

For an illustration of the present invention in an external connector mode, one embodiment computer keyboard is shown in FIG. 1. A CPU 10 is included within a keyboard 100, which provides a USB connector 20 or a PS/2 connector 30 with a cable 70 so as to connect to a computer host. Another PS/2 connector is also provided by the keyboard 100 so as to be connected with an external mouse or other peripheral. When the connector 20 or 30 is a different type from that on the computer host, an adaptor 40 is used to adaptively connect the keyboard 100 to the computer host.

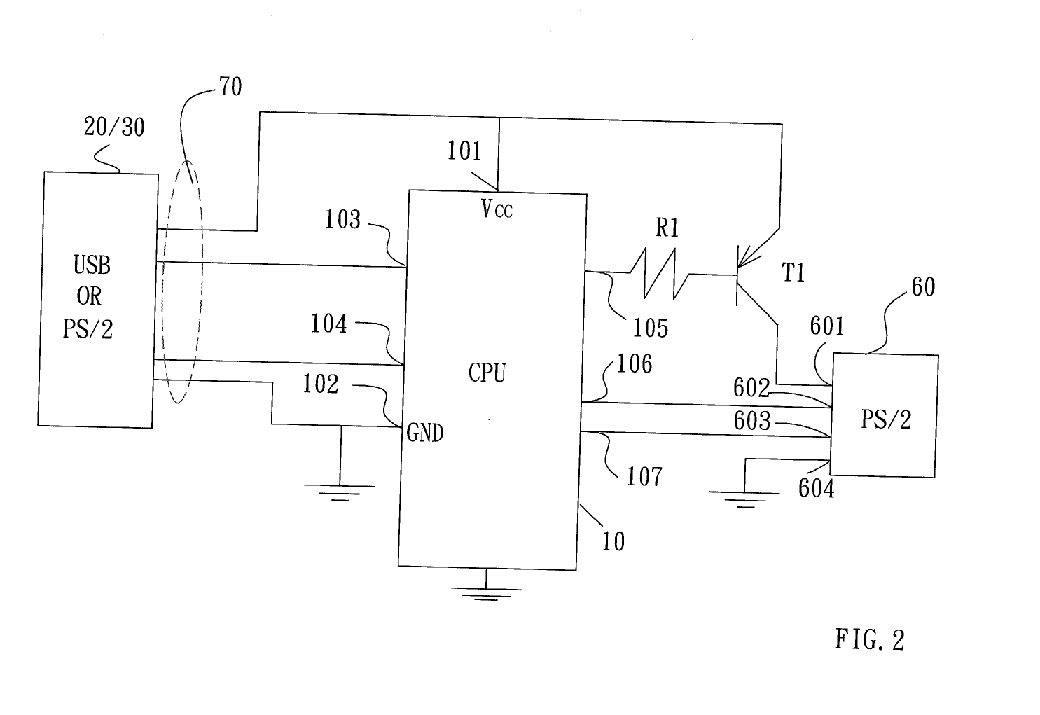

A circuit diagram for the embodiment shown in FIG. 1 is provided in FIG. 2, among which the CPU 10 has a first and second USB and PS/2 shared ports 103 and 104. When the keyboard 100 is connected to a computer host, the signals received on the shared ports 103 and 104 are used to determine the connector on the computer host is a USB connector or a PS/2 connector. The power port 101, ground port 102, shared ports 103 and 104 of the CPU 100 are respectively connected with the power terminal 201, ground terminal 204, data plus (DP) terminal 202 and data minus (DM) terminal 203 of the USB connector 20, or the power terminal 301, ground terminal 304, data terminal 302 and clock terminal 303 of the PS/2 connector 30. The CPU 10 also has a control port 105 connected to the base of a transistor T1 with a resistor R1. The emitter and collector of the transistor T1 are connected to the power port 101 on the CPU 10 and the power terminal 601 of the PS/2 connector 60 of the keyboard 100. The data terminal 602, clock terminal 603, and ground terminal 604 of the PS/2 connector 60 are respectively connected to the PS/2 ports 106 and 107 on the CPU 10 and ground reference. To serve as an electronic switch, the transistor T1 is turned on or off under control of the control port 105, such that the PS/2 connector 60 is enabled or disabled.

When the signals of the shared ports 103 and 104 of the CPU 10 are at low state, it is determined that a USB connector is used; contrarily, when the signals of the shared ports 103 and 104 of the CPU 10 are at high state, it is determined that a PS/2 connector is used. If a detection shows that a USB connector is used, then the transistor T1 is turned on by a control signal from the control port 105 of the CPU 10, such that the PS/2 connector 60 is enabled for an external mouse or other peripheral; on the contrary, if a detection shows that a PS/2 connector is used, then the transistor T1 is turned off by another control signal from the control port 105 of the CPU 10, such that the PS/2 connector 60 is disabled so as to prevent signal conflict with the PS/2 connector 30 due to their identical type.

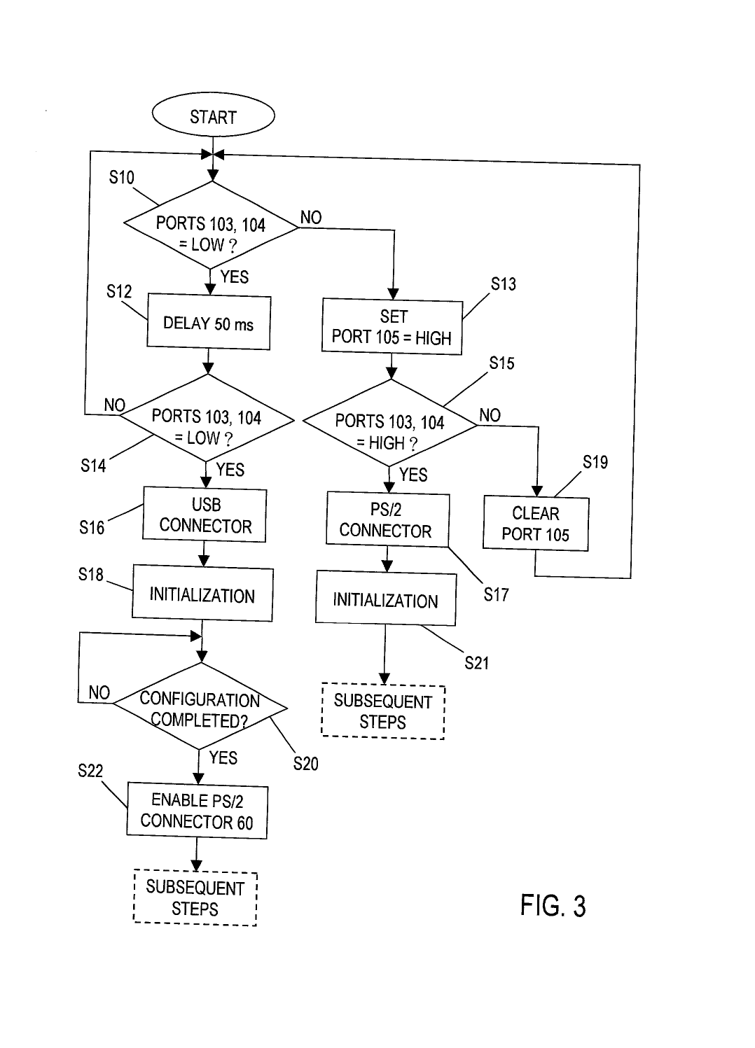

FIG. 3 demonstrates a detection workflow for the circuit shown in FIG. 2. First, in step S10 the CPU 10 detects if the signals on its first and second shared port 103 and 104 are at low state. If yes, then execute step S12, in which a time period of 30-100 ms is delayed, and 50 ms is preferred. Then in step S14, detection is made again if the signals on the first and second signal port 103 and 104 are still at low state. If yes, then execute step S16; otherwise, return to step S10. Step S16 determines that a USB connector is used, and then initialization step S18 is executed. After that, step S20 detects if the configuration of the USB connector is completed. If yes, then step S22 is executed; otherwise, return to step S20. Step S22 enables the PS/2 connector 60, and then other subsequent steps are executed, as normally in a computer system. When step S10 detects that the signals on the first and second shared ports 103 and 104 are not at low state, step S13 is executed to set the control port 105 of the CPU 10 to be high state, thus turning on the transistor T1. Step S15 in turn detects if the signals on the first and second shared ports 103 and 104 of the CPU 10 are at high state. If yes, then step S17 determines that a PS/2 connector is used, and then initialization step S21 and other subsequent steps, as normally in a computer system, are executed; otherwise, when the detection result of step S15 is false, step S19 clears the high state on the control port 105 of the CPU 10, thus turning off the transistor T1, which is step S19, and then return to step S10.

Since the pins of the first and second shared ports 103 and 104 of the CPU 10 are connected with the data plus terminal 202 and data minus terminal 203 of the USB connector 20 or the data terminal 302 and clock terminal 303 of the PS/2 connector 30 and different type connectors generates different signals, it can determine that the connector used is a USB connector or a PS/2 connector and in turn determine the computer keyboard to be operated with USB mode or PS/2 mode. Moreover, when the keyboard 100 is operated with USB mode, the PS/2 connector 60 can be used to connect with an external mouse or other peripheral.

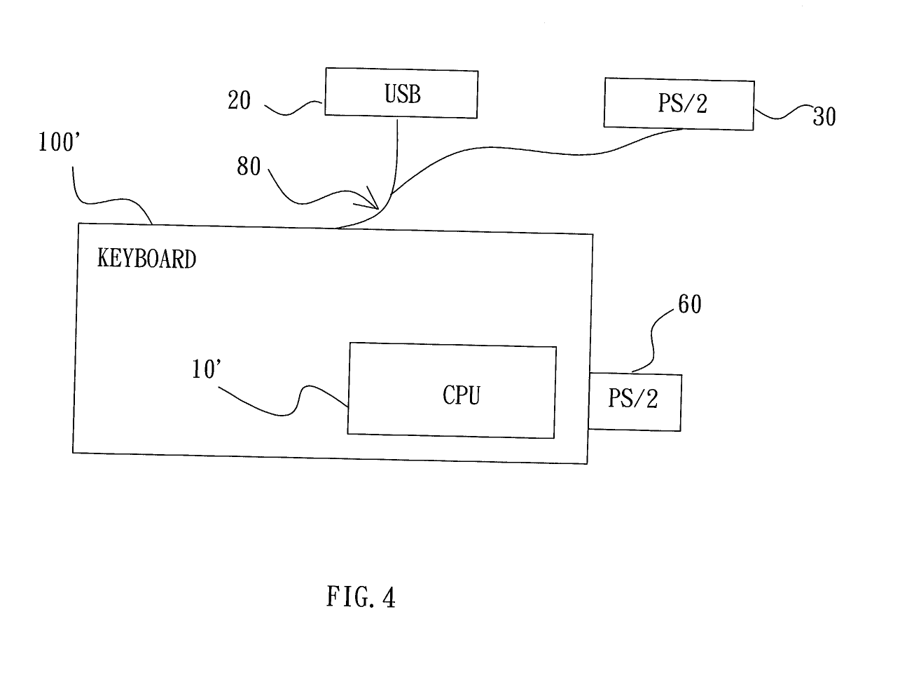

For an illustration of the present invention in a Y-cable mode, a second embodiment computer keyboard is shown in FIG. 4. A CPU 10′ is included within a keyboard 100′ that provides a USB connector 20 and a PS/2 connector 30 with a Y-cable 80 so as to connect to a computer host with different type connector. As same with the embodiment shown in FIG. 1, the keyboard 100′ also provides an another PS/2 connector 60 to connect with an external mouse or other peripheral.

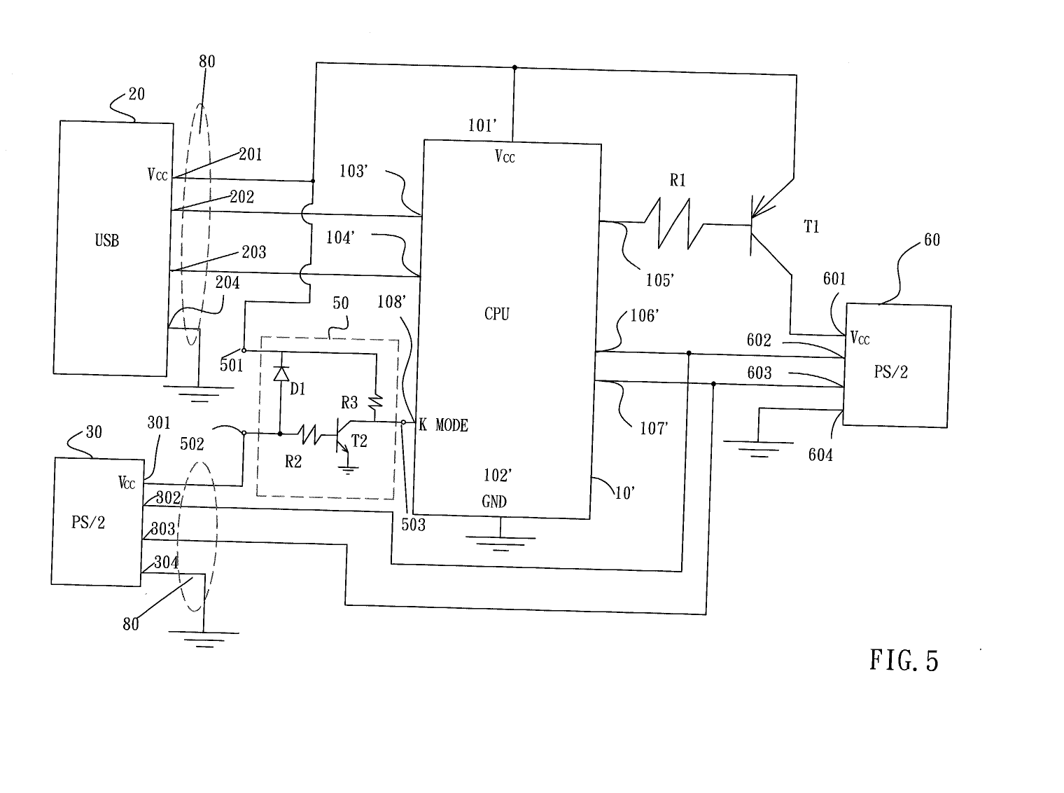

A circuit diagram for the embodiment shown in FIG. 4 is provided in FIG. 5, among which a mode detection circuit 50 has two input terminals 501 and 502 respectively connected to the power terminals 201 and 301 of the USB connector 20 and the PS/2 connector 30 and an output terminal 503 to provide a first or second mode signal to a mode detection port 108′ on the CPU 10′. When the keyboard 100′ is connected to a computer host, the CPU 10′ determines the connector used is the USB connector 20 or the PS/2 connector 30 by the mode detection port 108′. In the case the USB connector 20 is used, its power terminal 201, data plus terminal 202, data minus terminal 203 and ground terminal 204 are respectively connected to the power port 101′, data plus port 103′, data minus port 104′, and ground port 102′ on the CPU 10′. While in the case the PS/2 connector 30 is used, its data terminal 302, clock terminal 303, and ground terminal 304 are respectively connected to the data port 106′, clock port 107′, and ground port 102′ on the CPU 10′, and its power terminal 301 is connected to a resistor R2 and a diode D1. The other terminal of the diode D1 is connected to the power port 101′ on the CPU 10′ and the other terminal of the resistor R2 is connected to the base of a transistor T2. The collector of the transistor T2 is connected to the mode detection port 108′ on the CPU 10′ and a resistor R3. The other terminal of the resistor R3 is connected to the diode D1 and the power port 101′ on the CPU 10′. The emitter of the transistor T2 is grounded. The mode detection circuit 50 uses the transistor T2 as a mode switch and generates a first or second mode signal depending on the signals at the input terminals 501 and 502 of the mode detection circuit 50. The first mode signal is a high state signal and determines the keyboard in operation with USB mode; while the second mode signal is a low state signal and determines the keyboard in operation with PS/2 mode. When the PS/2 connector 30 is connected to a computer host, its power terminal 301 turns on the transistor T2 by the input terminal 502 of the mode detection circuit 50 and the resistor R2, thus the output terminal 503 is grounded and the second mode signal is outputted from the mode detection circuit 50. When the USB connector 20 is connected to a computer host and the PS/2 connector 30 is free, the transistor T2 will not be turned on. The power terminal 201 of the USB connector 20 makes the output terminal 503 of the mode detection circuit 50 to voltage Vcc by the input terminal 501 of the mode detection circuit 50 and the resistor R3, thus the first mode signal is outputted from the mode detection circuit 50.

The data terminal 602 of the PS/2 connector 60 is connected to the data port 106′ on the CPU 10′ and the data terminal 302 of the PS/2 connector 30. The clock terminal 603 of the PS/2 connector 60 is connected to the clock port 107′ on the CPU 10′ and the clock terminal 303 of the PS/2 connector 30. The ground terminal 304 of the PS/2 connector 60 is grounded. When the signal received by the mode detection port 108′ on the CPU 10′ is at high state, it means that the USB connector 20 is connected to a computer host and the PS/2 connector 30 is free; while it means that the PS/2 connector 30 is connected to a computer host when the signal received by the mode detection port 108′ on the CPU 10′ is at low state. If the keyboard 100′ is connected to a computer host with the USB connector 20, the transistor T1 is turned on by a control signal from the control port 105′ on the CPU 10′, thus enabling the PS/2 connector 60 available for an external mouse or other peripheral; if the keyboard 100′ is connected to a computer host with the PS/2 connector 30, then the control port 105′ on the CPU 10′ turns off the transistor T1, thus disabling the PS/2 connector 60 so as to prevent signal conflict with the PS/2 connector 30.

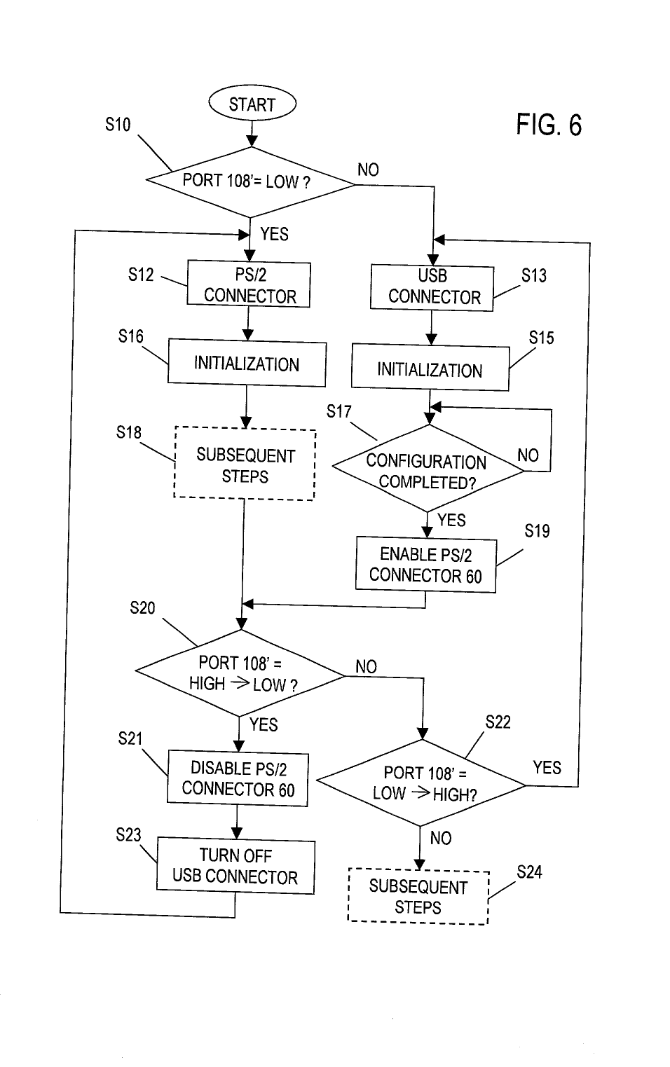

FIG. 6 demonstrates a detection workflow for the circuit shown in FIG. 5. First, step S10 detects if the signal on the mode detection port 108′ on the CPU 10′ is at low state. If yes, then step S12 is executed; otherwise, step S13 is executed. Step S12 determines that the PS/2 connector 30 is used, and then initialization step S16 and other subsequent step S18 as normally in a computer system are executed. After that, step S20 detects if the signal on the mode detection port 108′ on the CPU 10′ transits from high state to low state. If yes, step S21 is executed; otherwise, step S22 is executed. Step S21 disables the PS/2 connector 60 and Step S23 turns off the USB connector 20 and then returns to step S12. When the signal on the mode detection port 108′ on the CPU 10′ is at high state, step S13 is executed to determine that only the USB connector 20 is used. Then initialization step S15 is executed. Step S17 in turn detects if the configuration of the USB connector 20 is completed. If yes, then step S19 is executed to enable the PS/2 connector 60; otherwise, return to step S17. After step S19 enables the PS/2 connector 60, step S20 is executed. When the signal on the mode detection port 108′ on the CPU 10′ is detected to transit from high state to low state, step S21 is executed; otherwise, step S22 is executed to detect if the mode detection port 108′ on the CPU 10′ transits from low state to high state. If yes, return to step S13; otherwise, step S24 is executed, as normally in a computer system.

The mode detection port 108′ on the CPU 10′ is connected to the power terminals 201 and 301 of the USB connector 20 and the PS/2 connector 30 with the mode detection circuit 50 inserted therebetween, and thus detects the USB connector 20 or the PS/2 connector 30 is used by the power signal inputted from these two connectors 20 and 30 and transmits corresponding mode signal. In the case the USB connector 20 is used, the PS/2 connector 60 is enabled available for connecting with an external mouse or other peripheral; in the case the PS/2 connector 30 is used, the PS/2 connector 60 is disabled to avoid signal conflict with the PS/2 connector 30.

In the detection method of the first embodiment shown in FIGS. 1-3, the delay time of 30-100 ms and subsequent detection of the first and second shared ports 103 and 104 on the CPU 10 still at low state prevents possible signal error resulted from the data sent from the computer host to the PS/2 connector 30. In the second embodiment shown in FIGS. 4-6, if the USB connector 20 and the PS/2 connector 30 are both connected to a computer host, then the PS/2 connector 30 is selected to be available.

From the above, it should be understood that the embodiments described, in regard to the drawings, are merely exemplary and that a person skilled in the art may make variations and modifications to the shown embodiments without departing from the spirit and scope of the present invention. All variations and modifications are intended to be included within the scope of the present invention as defined in the appended claims.

What is claimed is:

1. An apparatus for automatically detecting USB mode and PS/2 mode keyboard, comprising:
a central processing unit (CPU) with a power port, a ground port, and a first and a second USB and PS/2 shared ports for externally connecting with a USB connector or a PS/2 connector;
wherein said CPU determines said keyboard in operation with USB mode or PS/2 mode depending on said first and second USB and PS/2 shared ports in connection with USB signal or PS/2 signal.

2. An apparatus according to claim 1, further comprising an adaptor connected with said external connector for USB connector to PS/2 connector or PS/2 connector to USB connector.

3. An apparatus according to claim 1, further comprising a control port and a first and a second PS/2 ports provided on said CPU; an electronic switch connected to said power port and control port respectively; and an another PS/2 connector connected to said first and second PS/2 ports, ground port and an output of said electronic switch; wherein said control port determines whether said electronic switch is turned on for providing power at said output of said electronic switch.

4. An apparatus according to claim 3, wherein said electronic switch is a transistor circuit.

5. An apparatus for automatically detecting USB mode and PS/2 mode keyboard, comprising:
a CPU having a power port, a ground port, a first and a second USB ports, a first and a second PS/2 ports, a control port, and a mode detection port;
a mode detection circuit having a first and a second input terminals, and an output port for providing a first or a second mode signal to said mode detection port;
a USB connector having a power terminal, a ground terminal, and a first and a second USB terminals respectively connected to said power port, ground port, and first and second USB ports, said power terminal of said USB connector connected to said first input terminal of said mode detection circuit; and
a PS/2 connector having a power terminal, a ground terminal, and a first and a second PS/2 terminals respectively connected to said second input terminal of said mode detection circuit, first and second PS/2 ports, and ground port;
wherein, said CPU determines said keyboard in operation with USB mode or PS/2 mode depending on said first or second mode signal received at said mode detection port.

6. An apparatus according to claim 5, wherein said mode detection circuit includes a mode switch for outputting said first or second mode signal depending on signals received at said first and second input terminals.

7. An apparatus according to claim 6, wherein said mode switch is turned on or off under control of said second input terminal for generating said first or second mode signal.

8. An apparatus according to claim 6, wherein said mode switch is a transistor circuit.

9. An apparatus according to claim 8, wherein said mode detection circuit further includes a diode circuit coupled between said first and second input terminals.

10. An apparatus according to claim 8, wherein said mode detection circuit further includes a resistance circuit coupled between said first input terminal and output terminal.

11. An apparatus according to claim 5, wherein said first mode signal is a high state signal and said second mode signal is a low state signal.

12. An apparatus according to claim 5, further comprising a control port provided on said CPU; an electronic switch connected to said power port and control port respectively; and an another PS/2 connector connected to said first and second PS/2 ports, ground port and an output of said electronic switch; wherein said control port determines whether said electronic switch is turned on for providing power at said output of said electronic switch.

13. An apparatus according to claim 12, wherein said electronic switch is a transistor circuit.

14. A method for automatically detecting USB mode and PS/2 mode keyboard, comprising the steps of:
(A) providing a power port, a ground port, and a first and a second USB and PS/2 shared ports on a CPU for externally connecting with a USB connector or a PS/2 connector;
(B) detecting said first and second USB and PS/2 shared ports at a first or a second state for executing step (C) or step (D);
(C) waiting a delay time and then detecting said first and second USB and PS/2 shared ports, if not said first state, then returning to step (B), else determining said keyboard in operation with USB mode; and
(D) detecting said first and second USB and PS/2 shared ports, if both at high state, then determining said keyboard in operation with PS/2 mode, else returning to step (B).

15. A method according to claim 14, wherein said first state is referred when both said first and second USB and PS/2 shared ports are at low state, else said second state is referred.

16. A method according to claim 14, wherein said delay time is set between 30 and 100 ms.

17. A method according to claim 14, further comprising the steps of:
providing an another PS/2 connector; and
enabling said another PS/2 connector when said first state is detected at step (B) for detecting said first and second USB and PS/2 shared ports.

18. A method according to claim 17, further comprising detecting said first and second USB and PS/2 shared ports after enabling said another PS/2 connector, if neither at said high state, then disabling said another PS/2 connector and returning to step (B).

19. A method according to claim 14, further comprising the steps of:
initializing USB keyboard after said USB mode is determined for said keyboard;
detecting said USB connector until completely configured; and
enabling said another PS/2 connector.

20. A method according to claim 14, further comprising initializing PS/2 keyboard after said PS/2 mode is determined for said keyboard.

21. A method for automatically detecting USB mode and PS/2 mode keyboard, comprising the steps of:
(A) providing a USB connector and a PS/2 connector;
(B) generating a first or a second mode signal depending on signals at a power terminal of said USB connector and a power terminal of said PS/2 connector; and
(C) determining said keyboard in operation with USB mode on said first mode signal and with PS/2 mode on said second mode signal.

22. A method according to claim 21, wherein said second mode signal is referred when said power terminal of said PS/2 connector at high state.

23. A method according to claim 21, wherein said power terminal of said PS/2 connector controls a mode switch for generating said second mode signal if a predefined signal at said power terminal of said PS/2 connector, else generating said first mode signal.

24. A method according to claim 21, further comprising the steps of:
providing an another PS/2 connector; and
enabling said another PS/2 connector if USB mode determined, and disabling said another PS/2 connector if PS/2 mode determined.

25. A method according to claim 21, further comprising initializing PS/2 keyboard after said PS/2 mode is determined for said keyboard.

26. A method according to claim 21, further comprising the steps of:
initializing USB keyboard after said USB mode is determined for said keyboard;
detecting said USB connector until completely configured; and
enabling said another PS/2 connector.

27. A method according to claim 21, further comprising the steps of:
disabling said another PS/2 connector if said first mode signal is transited to said second mode signal after USB mode is determined for the keyboard; and
determining said keyboard in operation with PS/2 mode.

28. A method according to claim 21, further comprising determining said keyboard in operation with USB mode if said second mode signal is transited to said first mode signal after PS/2 mode is determined for the keyboard.
